(19) United States
(12) Patent Application Publication
(10) Pub. No.: US 2015/0200918 A1
(43) Pub. Date: Jul. 16, 2015

(54) Multi Layered Secure Data Storage and Transfer Process

(71) Applicants: Muzhar Khokhar, Shrewsbury, MA (US); Joseph Bet-Eivazi, Methuen, MA (US)

(72) Inventors: Muzhar Khokhar, Shrewsbury, MA (US); Joseph Bet-Eivazi, Methuen, MA (US)

(21) Appl. No.: 14/157,483

(22) Filed: Jan. 16, 2014

(51) Int. Cl. H04L 29/06

(52) U.S. Cl. CPC H04L 63/0435; H04L 63/0442; H04L 63/061

(57) ABSTRACT

One embodiment of a data storage and transfer process between electronic devices where communicated data requires at minimum the participation of three factors before the data may be accessed on any device.

### BACKGROUND

### Prior Art

Methods for securely transferring data from one device to another are designed to prevent an unintended audience from being able to access the data. A method such the Diffie-Hellman key exchange, protects data being sent over an insecure channel from eavesdroppers, but allows full access of the data on both source and target devices. In this popular approach, both source and target devices are able to decode said data using their private keys at any time. This becomes a huge problem if say either device ends up in the custody of an unintended user or if the target device, the recipient of the data, should be later forbidden from accessing the data.

In other data transfer processes, the data may be encoded and stored on a server to prevent either device from accessing it alone. The problem with this approach is that should the server be hacked and all the encoded data pulled collected, the hacker simply needs the key to access the data. They key may even be on the server where the hacker can collect it as well or the hacker may obtain it from one of the devices that is authorized access.

In any current approach an unauthorized person will need, at most, only two devices to access the data.

### SUMMARY

In accordance with one embodiment, the Multi Layered Secure Data Storage and Transfer Process is a method of securely storing and transmitting data over a network where a minimum of three devices are necessary to access said data in order to maintain its secrecy.

### Advantages

Accordingly several advantages of one or more aspects are as follows: a data to be secured (data) is secured in a way that no component alone can access the data, no combination of two components can access the data, the data cannot be accessed by information sent through the channel, the data cannot be accessed by the source device alone, the data cannot be accessed by the target device(s) alone, the data cannot be accessed on the server or any other component of this embodiment alone, the data cannot be accessed by the source device and the target device(s) alone, the data cannot be accessed by the target device(s) and the server alone, the data cannot be accessed by the source device and the server alone, the data cannot be accessed by a user and the source device alone, the data cannot be accessed by a user and the server alone, the data cannot be accessed by a user and the target device alone. Other advantages of one or more aspects will be apparent from a consideration of the drawings and ensuing description.

### DRAWINGS

### Figures

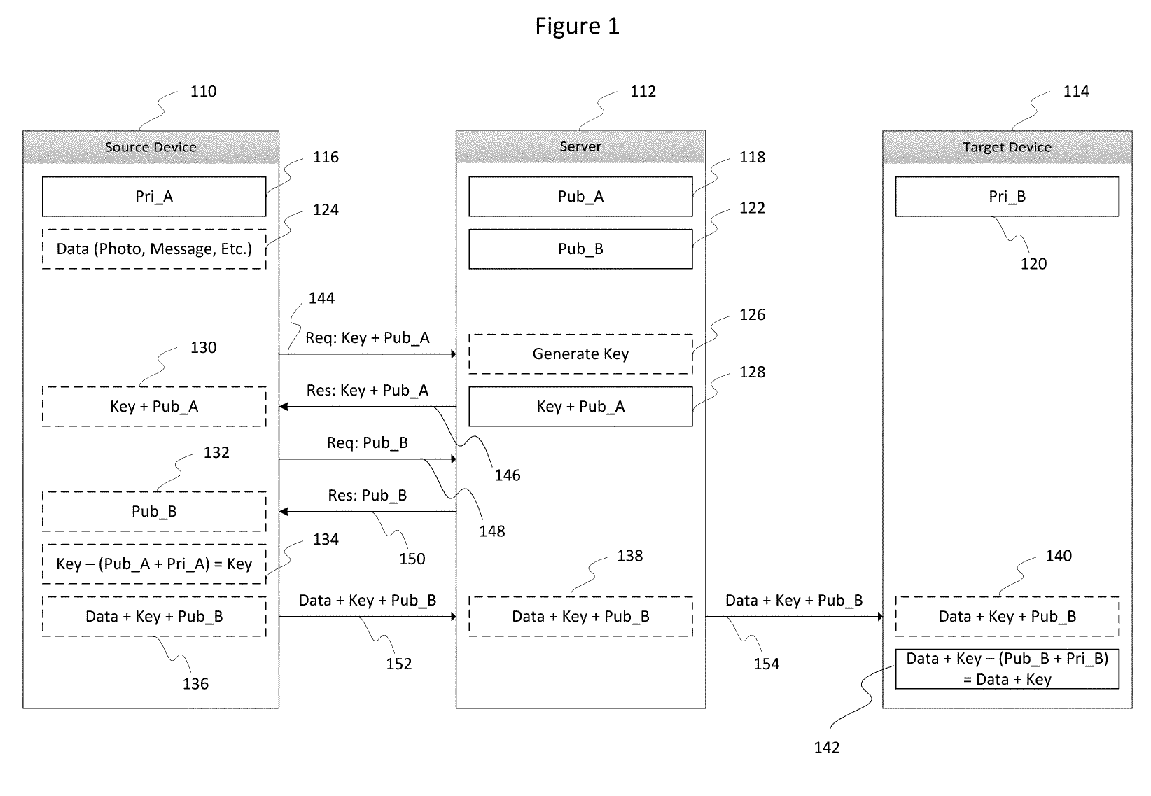

FIG. 1 illustrates an example flow diagram of a data transfer from a source to a target device in accordance with this embodiment.

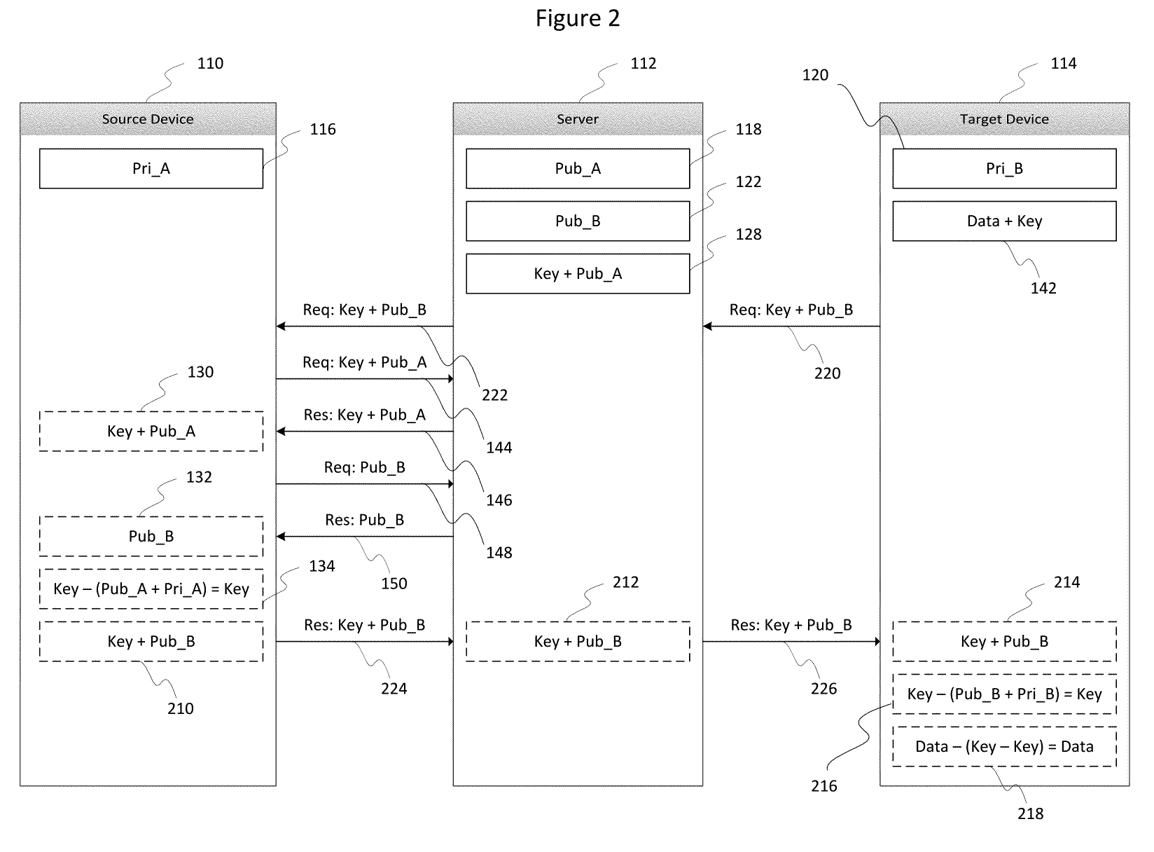

FIG. 2 illustrates an example flow diagram of a key exchange initiated by the target device in order for it to view the data after the data transfer as shown in FIG. 1.

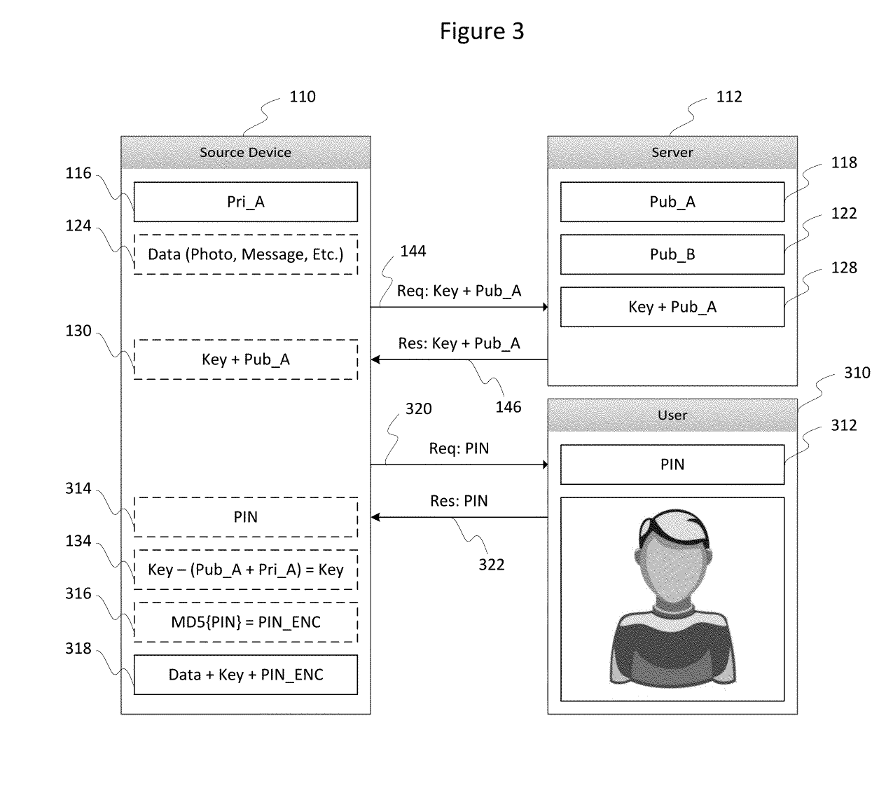

FIG. 3 illustrates an example flow diagram of the data being secured on the source device by a user of the source device.

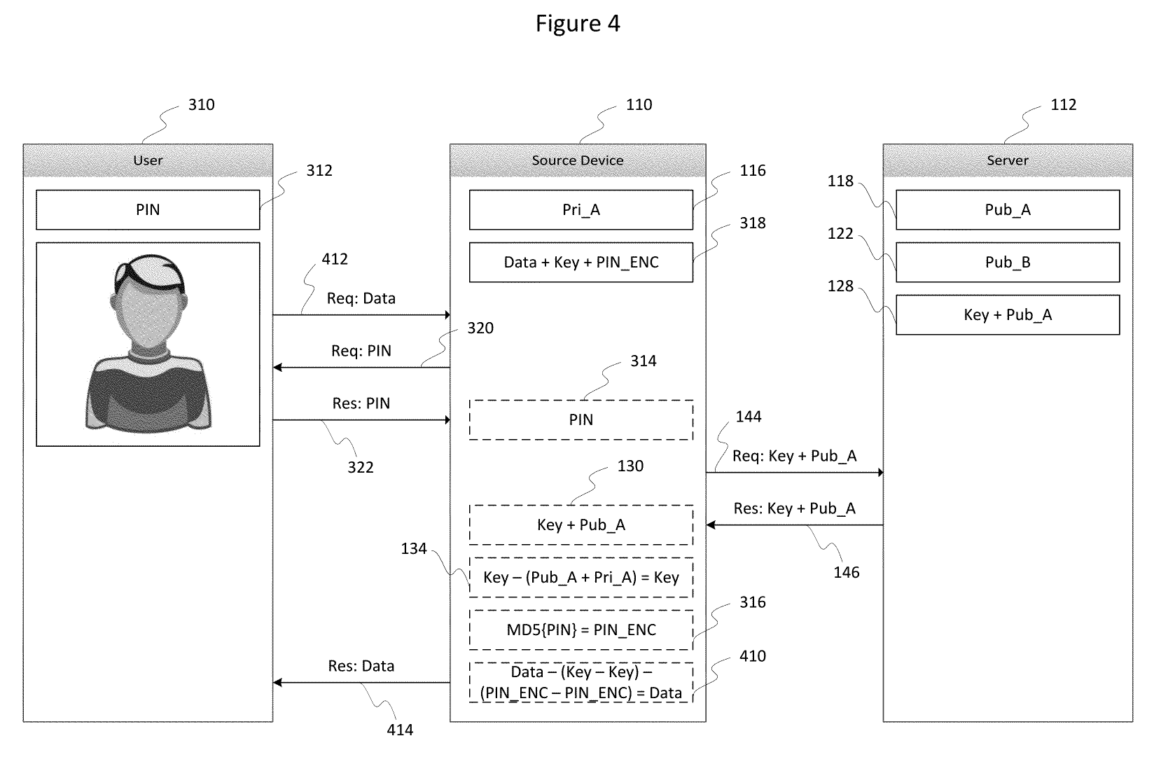

FIG. 4 illustrates an example flow diagram of the user accessing the secured data on the source device.

Drawings-Reference Numerals

| | | | |
|---|---|---|---|
| 110 | source device | 138 | encrypted data 136 on server 112 |
| 112 | server | 140 | encrypted data 138 on target device |
| 114 | target device | | 114 |
| 116 | private key of source device 110 | 142 | encrypted data 140 decoded with |
| 118 | public key of source device 110 | | private key 120, revealing an |
| 120 | private key of target device 114 | | encoding of data 124 with key 126 |
| 122 | public key of target device 114 | 144 | request from source device 110 to |
| 124 | data to communicate securely from | | server 112 for encoding 128 |
| | source device 110 to target device | 146 | response from server 112 to source |
| | 114 | | device 110 with encoding 128 |
| 126 | randomly generated key | 148 | request from source device 110 to |
| 128 | key 126 encoded with public key 118 | | server 112 for public key 122 |
| | on server 112 | 150 | response from server 112 to source |
| 130 | encoded data 128 on source device | | device 110 with public key 122 |
| | 110 | 152 | encrypted data 136 communicated |
| 132 | public key 122 on source device 110 | | from source device 110 to server |
| 134 | encoding 130 decoded with private | | 112 |
| | key 116, revealing key 126 | 154 | encrypted data 138 communicated |
| 136 | data 124 encrypted with key 126 | | from server 112 to target device 114 |
| | generated from decoding 134 and | | |
| | public key 132 | | |
| 210 | key 134 encoded with public key 132 | 220 | request from target device 114 to |
| | on source device 110 | | server 112 for encoding 210 |
| 212 | encoding 210 on server 112 | 222 | request from server 112 to source |
| 214 | encoding 212 on target device 114 | | device 110 for encoding 210 |
| 216 | encoding 214 decoded with private | 224 | response from source device 110 to |
| | key 120, revealing key 134 | | server 112 with encoding 210 |
| 218 | encoding 142 decoded with the | 226 | response from server 112 to target |
| | resulting key of decoding 134, | | device 114 with encoding 212 |
| | revealing data 124 | 318 | data 124 encrypted with key 134 |
| 310 | user of source device 110 | | and encrypted PIN 316 |
| 312 | Personal identification number (PIN) | 320 | request from source device 110 to |
| | of user 310 | | user 310 for PIN 312 |
| 314 | PIN 312 on source device 110 | 322 | response from user 310 to source |
| 316 | PIN 312 encrypted using a function, | | device 110 with PIN 312 |
| | resulting in an encrypted PIN | 412 | request from user 310 to source |
| 410 | encryption 318 decrypted with key | | device 110 for data 124 |
| | 134 and encrypted PIN 316, | 414 | response from source device 110 to |
| | resulting in data 124 | | user 310 with data 124 |

### DETAILED DESCRIPTION

### FIG. 1—First Embodiment

One embodiment of the devices during for the transfer of a data 124 from a source device 110 to a target device 114 is illustrated in FIG. 1A. The process consists of three separated devices: the source device 110 which holds the data 124 to be communicated, the target device 114 to where the data 124 should be communicated securely to, and a server 112 which helps the source device 110 and target device 114 communicate.

In the illustrations, items surrounded by solid black borders, such as private key 116 on the source device 110, are to be saved on the device for use. On the other hand, items surrounded by dotted black borders, such as public key 132 on the source device 110, are only temporarily generated, used, then immediately destroyed.

The source device 110, contains private key 116 used to decode data encoded with public key 118. Data encoded using any public key can only be decoded with the corresponding private key, in accordance to asymmetric key encryption. Source device 110 also contains the data 124 which is to be communicated securely to the target device 114. Source device 110 receives encoding 130 from the server and is able to decode it using private key 116, in accordance to the discussed asymmetric key encryption, revealing a value equal to the key 126.

Source device 110 also contains the temporary public key 132 of the target device 114, which it also receives from the server 112. Source device 110 also temporarily contains the data 124 encrypted using key 126, generated from decoding 134, and public key 132. Both keys 120 and 126, or key equivalent to them, are needed to fully decrypt encryption 136.

The target device 114, contains private key 120, used to decode only one layer of encryption 140 at 142. The result of decoding encryption 142 with private key 120 results in an encoding of data 124 with key 126. Encrypted data decoded with only one of the needed keys, results in data encoded with the other key. The resulting encoding at 142 is saved on the target device to be accessed when allowed by the source device 110 and server 112.

Server 112 contains public key 118, which is used to encode a generated key 126 at 128. The encoding at 128 allows only the source device 110 with access to private key 116 to decode encoding 128. Server 112 also contains public key 122 which is transmitted to source device 110 when requested to encode data to be sent to target device 114, allowing only the target device 114 access to it. The server also temporarily contains a randomly generated key 126, in accordance to symmetric key encryption. This means that data encoded with key 126 can be decoded with the same key 126.

The server 138 also temporarily contains encrypted data 138, which is to be transferred to the target device 114. For security purposes, the source device 110 and the target device 114 never communicate directly with each other. Every message send between devices 110 and 114 must be transmitted through the server 112.

### FIG. 2 First Embodiment

FIG. 2 illustrates the key exchange initiated from target device 114. The three devices: the source device 110, the target device 114, and the server 112, remain the same from the previous description of FIG. 1. Many of the requests, responses, and device items also remain the same therefore will not be covered again in this description. The target device 114 still requires key 126 to finish decoding encoding 142 from FIG. 1. Key 126 encoded with public key 122 before being sent to target device 114 to maintain the key's secrecy. Only target device 114 is able to decode encoding 214 at 216. After decoding encoding 142 at 218 with the resulting key of 216, data 124 is now accessible to target device 114.

### FIG. 3 First Embodiment

FIG. 3 illustrates the process of saving data 124 on source device 110. Data 124 is encrypted with both server key 126 and user PIN 312 to maintain the data's secrecy in accordance to the claims. This embodiment uses a PIN as we have found it to be simplest for the user to enter, but any input which can identify the user of the device is acceptable. Source device 110 and server 112 remain the same from previous FIGS. 1 & 2. A new user 310 is added who contains a PIN which is used to verify his identity. At 316, PIN 314 is transformed into a symmetric key so that the same PIN can encode and decode data. This embodiment uses a Message-Digest Algorithm (MD5) but any key generating functions/algorithms are acceptable. The MD5 produces a 128 bit “fingerprint” of PIN 314.

### FIG. 4 First Embodiment

FIG. 4 illustrates the process required from user 310 to access data 124 on source device 110. Many of the process steps remain similar from FIG. 3 therefore will not be covered again in this description. New to FIG. 4 is decryption 410 uses symmetric key 126, as a result of decoding 134, and the result of encoding 316 of PIN 314. Decryption 410 results in data 124 which is now accessible to user 310.

Operation—FIG. 1

The manner to securely transfer data 124 from source device 110 to target device 114, begins with request 144 from source device 110 to server 112 for key encoding 128. Server 112 then generates a random key 126 and encodes it with public key 118, resulting in key encoding 128. Server 112 responds to request 144 with response 146. Response 146 contains the encoding 128. Source device 110 receives transmission 146 at 130 and temporarily stores it. Source device 110 then transmits request 148 to server 112 for public key 122. Server 112 responds to request 148 with response 150. Response 150 contains public key 122. Source device 110 receives response 150 at location 132. Encoding 130 is decoded at 134 using private key 116, resulting in the key 126. Source device 110 encrypts data 124 with the result of decoding 134, synonymous to key 126, and public key 132 at 136. Source device 110 transmits encryption 136 to server 112 through transmission 152. Server 112 receives transmission 152 at 138. Server 112 transmits encryption 138 to target device 114 through transmission 154. Target device 114 receives transmission 154 at 140. Encryption 140 is decoded using private key 120 at 142, resulting in the encoding of data 124 with key 126.

Operation—FIG. 2

The manner to securely transfer encoding 210 from source device 110 to target device 114, begins with key request 220 from target device 114 to server 112 for encoding 210. Server 112 receives request 220 and transmits request 222 to source device 110. Source device 110 receives request 222 and responds by transmitting request 144 to server 112 for encoding 128. Server 112 receives request 144 and responds with request 146. Source device 110 receives response 146 at 130. Source device 110 then transmits request 148 to server 112 for public key 122. Server 112 responds to request 148 with response 150. Response 150 contains public key 122. Source device 110 receives response 150 at location 132. Encoding 130 is decoded at 134 using private key 116, resulting in the key 126. Source device 110 encodes the key result of decoding 134 with public key 132. Source device 110 transmits encoding 210 to server 112 through response 224, in accordance to the original request 222. Server 112 receives response 224 at 212. Server 112 transmits encoding 212 to target device 114 through response 226, in accordance to request 220. Target device 114 receives transmission 226 at 214. Target device 114 decodes encoding 214 with private key 120 at decoding 216, resulting in key 126. Target device 114 uses the resulting key 126, from decoding 216, to decode encoding 142 at decoding 218, resulting in data 124.

Operation—FIG. 3

The manner to secure data 124 on source device 110 in accordance to this embodiment begins with request 144 from source device 110 to server 112 for key encoding 128. Server 112 responds to request 144 with response 146. Response 146 contains the encoding 128. Source device 110 receives transmission 146 at 130 and temporarily stores it. Source device 110 then transmits PIN request 320 to user 310. User 310 responds with PIN 312 through response 322. Response 322 is received at 314 and temporarily stored. Encoding 130 is decoded at 134 using private key 116, resulting in the key 126. PIN 314 is encoded with a symmetric key generating function at 316. Source device 110 encrypts data 124 with the result of decoding 134, synonymous to key 126, and the result of encoding 316.

Operation—FIG. 4

The manner to access data 124 on source device 110 in accordance to this embodiment begins with request 412 sent from the user 310 to source device 110 asking for data 124. Source device 110 then transmits PIN request 320 to user 310. User 310 responds with PIN 312 through response 322. Response 322 is received at 314 and temporarily stored. Source device 110 transmits request 144 to server 112 for key encoding 128. Server 112 responds to request 144 with response 146. Response 146 contains the encoding 128. Source device 110 receives transmission 146 at 130 and temporarily stores it. Encoding 130 is decoded at 134 using private key 116, resulting in the key 126. PIN 314 is encoded with a symmetric key generating function at 316. Source device 110 decrypts data 124 with the result of decoding 134, synonymous to key 126, and the result of encoding 316.

Conclusion, Ramifications, and Scope

Thus the reader will see that at least one embodiment of the system allows for secure data storage and communication between device where no one or combination of two devices has authority to access the secured data.

While my above description contains many specificities, these should not be construed as limitations on the scope, but rather as an exemplification of one embodiment thereof. Many other variations are possible. For example, using other means for identifying the user of the source device instead of asking for his PIN or using different key generating functions that the one used in this first embodiment.

Accordingly, the scope should be determined not by the embodiment illustrated, but by the appended claims and their legal equivalents.

We claim:

1. A method for securely transmitting a data using a plurality of security measures, comprising:
A source device having an asymmetric private key and a server having an asymmetric public key, in accordance to public/private key encryption;
A target device having an asymmetric private key and a server having an asymmetric public key, in accordance to public/private key encryption;
A method for securely transmitting the data from a source device to a target device;
A method for accessing the data on the target device.

2. The method of claim 1 wherein securely transmitting the data from the source device to said target device comprises of:
A method for the source device to securely acquire a symmetric key, which is encrypted using the source device's public key, from the server;
The source device acquiring an asymmetric public key of the target from the server;
The source device encrypting the data with the symmetric key and the asymmetric public key;
The source device transmitting the encrypted data to the server;
The server transmitting the encrypted data to the target device.

3. The method of claim 2 wherein the source device securely acquiring the symmetric key from the server comprises of:
The server generating the symmetric key;
The server encoding the symmetric key with the asymmetric public key of the source device;
The server storing the encrypted symmetric key in memory;
The server transmitting the encrypted symmetric key to the source device;
The source device decrypting the encrypted symmetric key with the asymmetric private key stored in the source device.

4. The method of claim 1 wherein accessing the data on the target device comprises of:
A method for said target device to securely acquire the symmetric key;
The target device decrypting the encryption using the symmetric key and the private key of the target device.

5. The method of claim 4 wherein the target device securely acquiring the symmetric key includes:
The target device requesting the symmetric key;
The source device obtaining the symmetric key;
The source device obtaining the public key of the target device;
The source device encoding the symmetric key with the public key of the target device;
The source device transmitting the encrypted symmetric key to the target device.

6. The method of claim 5 wherein the source device securely acquiring the symmetric key includes:
The source device requesting the encrypted symmetric key from the server;
The server retrieving the encrypted symmetric key from memory;
The server transmitting the encrypted symmetric key to the source device;
The source device decrypting said encrypted symmetric key with the private key of the source device.

7. A method for securely storing the data using a plurality of security measures, comprising:
A method for storing the data on the source device;
A method for accessing the data on the source device.

8. The method of claim 7 wherein storing the data on the source device consists of:
The source device requesting and accepting a user identification data;
A method for the source device to securely acquire the symmetric key, which is encrypted using the source device's public key, from the server;
The source device transforming the user identification data into a user symmetric key;
The source device encrypting the data with the user symmetric key and the server symmetric key;
The source device storing the encrypted data in memory.

9. The method of claim 8 wherein the source device securely acquiring the symmetric key includes:
The source device requesting the encrypted symmetric key from the server;
The server retrieving the encrypted symmetric key from memory;
The server transmitting the encrypted symmetric key to the source device;
The source device decrypting said encrypted symmetric key with the private key of the source device.

10. The method of claim 7 wherein accessing the data on the source device consists of:
The user requesting the data from the source device;
The source device requesting and accepting the user identification data;
A method for the source device to securely acquire the symmetric key, which is encrypted using the source device's public key, from the server;
The source device transforming the user identification data into the user symmetric key;
The source device decrypting the encryption in memory with the user symmetric key and the server symmetric key;
The source device presenting the data to the user.

11. The method of claim 10 wherein the source device securely acquiring the symmetric key includes:
The source device requesting the encrypted symmetric key from the server;
The server retrieving the encrypted symmetric key from memory;
The server transmitting the encrypted symmetric key to the source device;
The source device decrypting said encrypted symmetric key with the private key of the source device.
